(19) United States
(12) Patent Application Publication
(10) Pub. No.: US 2012/0159237 A1
(43) Pub. Date: Jun. 21, 2012

(54) System and Method of Emergency Operation of an Alarm System

(75) Inventors: Axel Skrodzki, Essen (DE); Friedhelm Kramer, Dormagen (DE); Michael Gasthuys, Kamp-Lintfort (DE); Hubert Willms, Stolberg (DE)

(73) Assignee: Honeywell International Inc., Morristown, NY (US)

(21) Appl. No.: 12/970,351

(22) Filed: Dec. 16, 2010

(51) Int. Cl. G06F 11/20

(52) U.S. Cl. 714/5.1; 714/E11.072

(57) ABSTRACT

An ambient condition monitoring system includes a common control unit, at least one primary communications bus and at least one supplemental communications bus. The control unit communicates with a plurality of supplemental units, which could include ambient condition detectors, using the primary communications bus in a normal operating environment. In the event of a sensed failure of the primary bus, or one of the supplemental units, communications can be automatically implemented using the supplemental communications bus.

### FIELD

The invention pertains to alarm systems. More particularly, the invention pertains to such systems which incorporate redundant communications channels to compensate for communications failures between, or, in selected system modules.

### BACKGROUND

In known, distributed fire alarm systems, a fire-alarm control panel (FACP) communicates via one or more communications bus(es) and an associated communications protocol, with a number of subunits. The subunits may be implemented as bus control units, called bus masters. Each of the bus masters manages a number of detectors and/or actors, such as audible or visual alarm indicating devices, or voice alarms.

A communications failure between the FACP and a bus master or between a bus master and a detector may be caused by a failure of control circuitry, for example a programmed processor (CPU), of the FACP, or the control circuitry, a CPU for example, of a bus master, loss of a power supply, or a failure of on board components. Such failures can make the system inoperative.

It would be desirable to be able to automatically respond to failure conditions with a back-up mode which might provide a significant portion of the functionality of a normally operating system, until maintenance can be carried out and the system restored to normal operation.

### BRIEF DESCRIPTION OF THE DRAWINGS

FIG. 1 is a block diagram of a system which embodies the invention;

FIG. 2 is a block diagram illustrating aspects of switching and control circuitry of bus master units of FIG. 1; and

FIG. 3 is a diagram of an exemplary wave form in accordance with the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

Embodiments of the invention provide an additional, redundant, communication channel; or bus, connecting the detectors, or the actors, and the FACP. A protocol is provided for activating that channel, or bus, upon detection of a failure of the communications between the FACP and a bus master or a failure of the bus master's CPU. As a result, the system remains operative in the following cases:
failure within the FACP (CPU or power supply);
failure within a bus master (CPU or power supply, or local component failures);
failure of communications between the FACP and a bus master;
failure of communications between the bus master and a detector or actor.

In embodiments of the invention, even in case of any such failure:
alarm messages can still be transmitted to the local fire station;
actors (flashers, sounders, voice alarms) can remain synchronized and/or active;
full load operation even during emergency operation; and
the feature of isolating a line break or a line short remains active, too.

In a further aspect of the invention, the failure of a central processing unit does not result in the failure of the system as a whole. Central processing units include, for example, the programmable processor on the central, or common control unit of the system, or the controller of each of the bus master units. In embodiments of the invention, even if one of these components fails, an alarm signal, or, notification will still be transmitted correctly via the monitoring unit in the event of fire.

To implement an alternate, back-up communication path, an additional alarm indicating control line and a redundant voltage supply are provided on the central control unit. In addition, a redundant alarm detection path is implemented on the each of the bus master units.

The bus master modules are linked with the central controller via a multiple conductor bus. Communication between the central controller and the bus masters takes place via this bus. The central controller checks for the presence of the master modules at regular intervals. These regular queries from the central controller are considered by the master to be the “heartbeat” of the central controller. If the regular queries fail to arrive, this signifies to the bus master that any notification of fire that is detected can only be transmitted via the alternate fire indicating communication link.

In another aspect of the invention, exemplary hardware of a bus master has a primary side and a secondary side. One processor can be located on the primary side. On the secondary side a second processor can be provided. A plurality of executable instructions can be coupled to each of the processors. Each plurality of instructions can be stored in a computer readable medium, such as programmable read-only memory.

The processors can communicate with one another using interface circuitry coupled between the processors. Peer-to-peer or master-slave communications protocols can be used to implement inter-processor communications. Connections between the two processors can be implemented using optical isolators, or magnetic isolators.

When a malfunction occurs on the secondary side of the respective bus master, it is either detected by the primary side processor, or is communicated to the primary side processor by the secondary side processor via the inter-processor interface. In the event of a malfunction, the primary side processor activates the redundant alarm detection path. It does this by switching the bus master to a redundant power supply provided by the FACP. This provides a continued power supply to the bus devices and disconnects the secondary side of the bus master from the bus.

The primary side processor is preferably able to regulate the level emergency supply voltage from the central controller via a communication link and, at the same time, can measure the load current.

In one aspect of the invention, the secondary processor can, at regular intervals, transmit commands and data to the primary side processor and can request data from the primary side processor. If the communication request from the primary side processor is not correctly responded to, the secondary side processor can send a malfunction notification via a bus conductor to the central controller. The redundant alarm detection path is not used in this scenario.

Conversely, if the primary side processor does not receive any communication requests from the secondary side processor, it can activate the redundant alarm detection path after a predefined period of time. In this configuration, alarm notification information from a detector can be transmitted directly to the common control, or, monitoring unit via the redundant communication path.

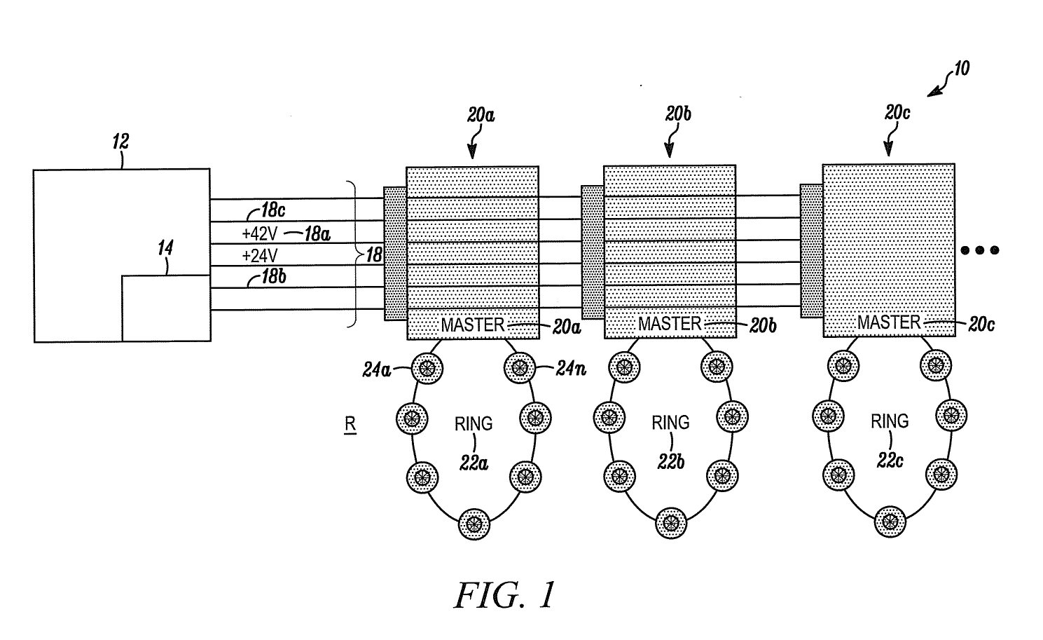

FIG. 1 is a block diagram of a monitoring system 10 in accordance with the invention. System 10 includes a common or, central control unit 12, which could correspond for example to a Fire Alarm Control Panel. Control unit 12 includes an ambient condition, for example fire or gas, monitoring unit. Unit 14, a communication or transmission unit, can notify the local fire department of an alarm condition. It can be triggered by control unit 12. It can function without the central control unit 12 and may be actuated by one or more bus masters, described below, via line 18b.

A multi-conductor bus structure 18 extends from control unit 12. One or more bus master units 20a, b, c . . . n can be coupled to the bus structure 18.

Each of the bus master units, such as 20a, can be coupled to a respective loop such as 22a. Each of the loops is coupled to a plurality of ambient condition detectors, or output devices, 24a . . . 24n. In a normal operating state, the common control unit 12 periodically communicates with the bus masters, such as 20a, b, c . . . n. The receipt of these signals from unit 12 at a respective bus master, such as 20a, confirms continued proper operation of the unit 12. In this instance the bus masters communicate alarm indicating information from various of the detectors such as 24a, via standard communication links of the bus structure 18. Such communications and associated protocols would be known to and understood by those of skill in the art and need not be discussed further.

In addition to the standard communications links, for normal operation, in accordance with the invention several additional, back-up, links can be provided in the bus structure 18 to be used in the event of a detected failure. These include a back-up power supply link 18a and an emergency alarm condition indicating signal line or link 18b. In the absence of periodic communications from the central control unit 12, the bus masters switch to the back-up alarm indicating communications link 18b to forward communications from the various detectors, such as 24a, to the control unit 12, or transmission unit 14.

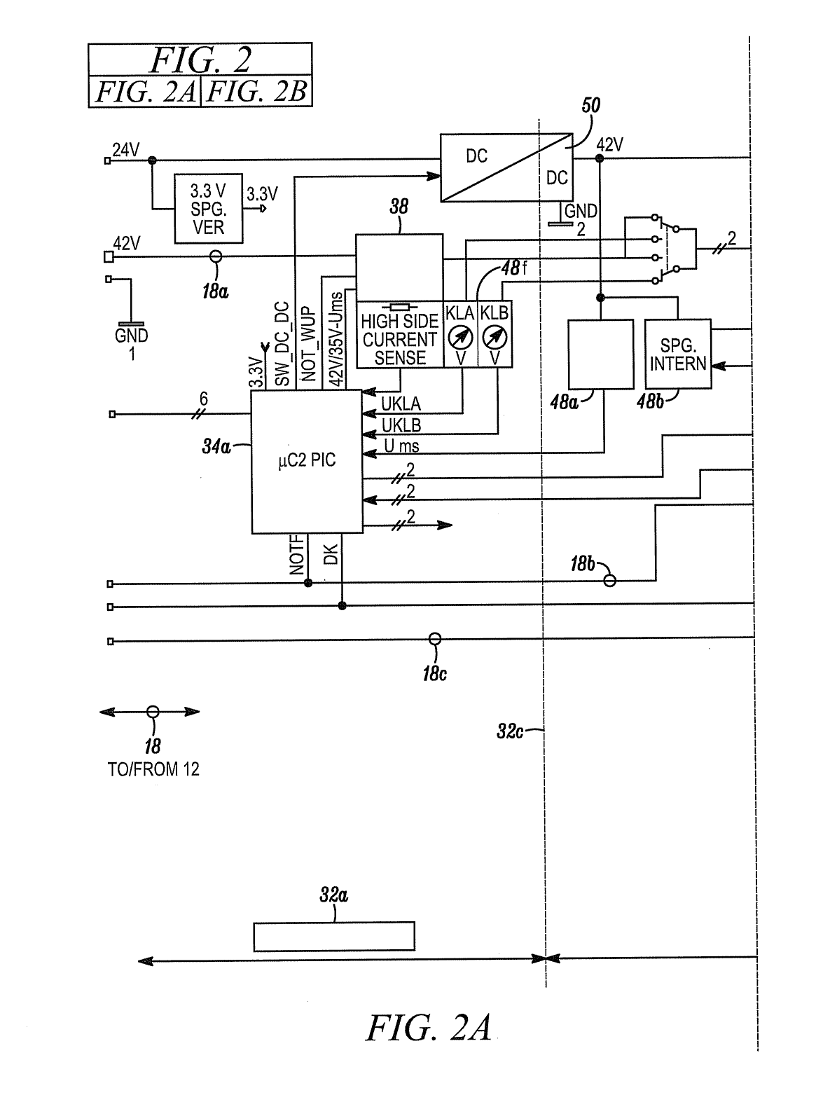

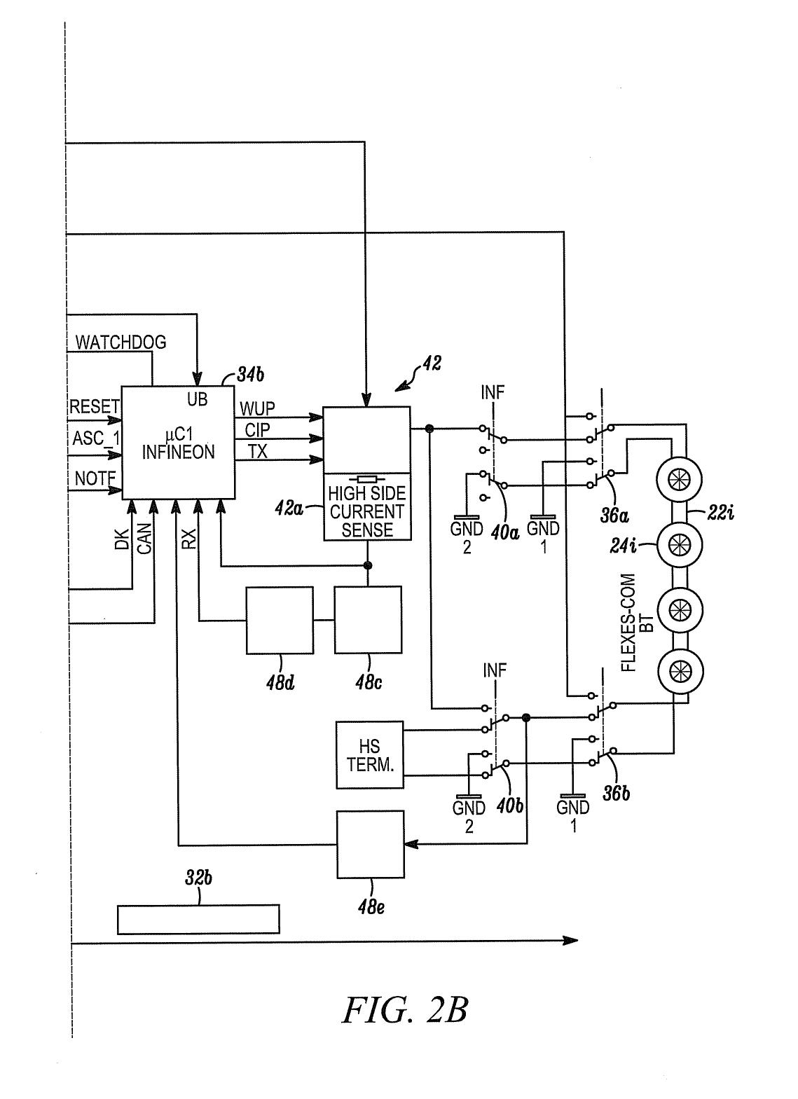

FIG. 2 is a block diagram illustrating exemplary communications circuitry of a representative bus master 20i. Exemplary hardware of the bus master 20i has a primary side 32a and a secondary side 32b. One processor 34a can be located on the primary side. The primary side is at the potential of the central controller and can communicate with the central control unit 12 via the bus structure 18.

The secondary side 32b of the bus master 20i is electrically isolated, as at 32c from the primary side 32a. On the secondary side is a second processor 34b with required transmission and reception stages. All connections between the two processors can be implemented using optical couplers or magnetic isolators.

When a malfunction occurs on the secondary side, such as 32b, of the respective bus master, it is either detected by the primary side processor 34a, or is communicated to the primary side processor 34a by the secondary side processor 34b via an interface. In the event of a malfunction, the primary side processor 34a activates the redundant alarm detection path. It does this by switching emergency relays 36a, b in the bus master to a redundant 42 volt power supply from the central controller. The processor 34a activates bypass output stage, or circuits 38 to switch the relays 36a, b. This provides a continual supply of power to the bus devices such as 24i and disconnects the secondary side 32b of the bus master 20i from the bus 18.

Communication between the primary side 32a and secondary side 32b controllers 34a, b can be carried out using a serial UART protocol based on a master and slave principle. The secondary side processor 34b can function as the master, while the primary side processor 34a can function as the slave. The master can transmit commands and data to the primary side processor and can request data from the primary side processor. Preferably, at regular intervals, the master transmits a communication request to the primary side processor. This querying is the means by which the primary side and the secondary side processors can monitor one another.

If the communication request from the primary side processor 34a is not correctly responded to, the secondary side processor 34b can send a malfunction notification via a bus conductor 18c to the central controller 12. The redundant alarm detection path is not used in this scenario.

Conversely, if the primary side processor 34a does not receive any communication requests from the secondary side processor 34b, it activates the redundant alarm detection path after a predefined period of time. In this configuration, alarm, for instance fire or gas alarm, notification that may be pending can still be transmitted directly to the common control, or, monitoring unit 12 via the alternate emergency indicating line 18b on the bus structure 18.

Relays 40a,b are used for communication with the respective loop 22i during normal operation. Further as illustrated in FIG. 2, backup relays 36a, b can be activated by processor 34a which can provide 42 volts back-up power to the loop 22i. Additional components include voltage monitor 48a, internal voltage monitor 48b, amplifier 48c, receiver 48d, voltage sensor 48e, and two channel voltage monitor 48f.

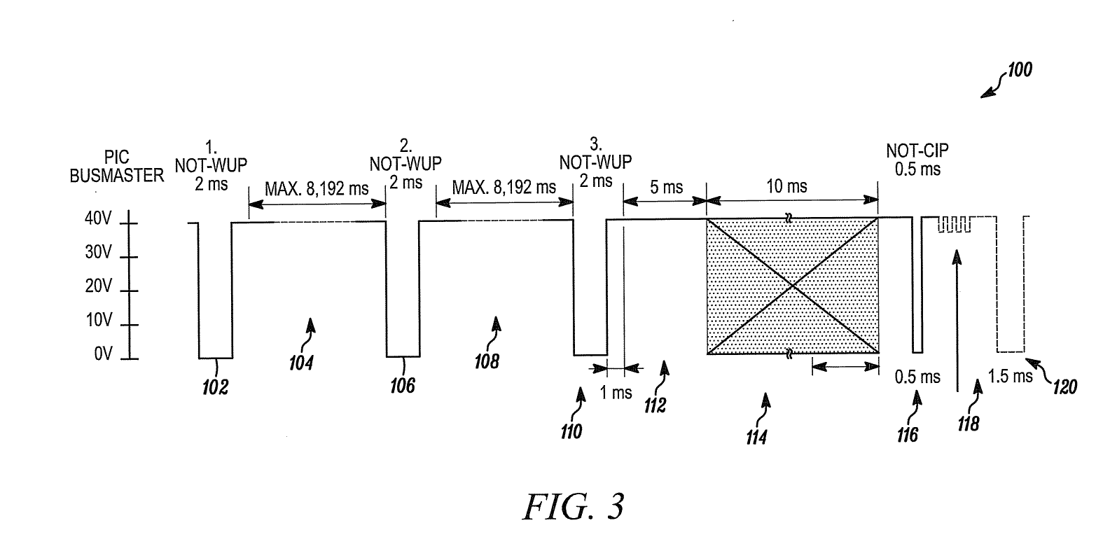

FIG. 3 is a diagram of a single cycle of a waveform 100 and associated protocol generated by processor 34a in response to activation of the alternate alarm notification path as discussed above. An initial 2 ms pulse 102 is first generated. A variable pulse length synchronization signal 104 is then generated followed by a second 2 ms pulse 106. Another variable pulse length synchronization signal 108 is then generated followed by another 2 ms pulse 110. For synchronization, a reference time is sent by varying two pulse lengths 104, 108. With a maximum duration of 8.192 ms and a resolution of 32 us, exactly 256 states can be coded in one pulse, which results in a total resolution of 65536 states, or 16 bits (2 bytes). All bus devices read this time stamp and adjust their own, internal timer to this reference.

Short circuit monitoring is initiated at 112 with closure of an isolator switch which takes place one milli-second after the rising edge of 110. Subsequently, a short circuit can be simulated, as at 114, if an overcurrent was detected. Multiple measurements can be made, for example, three measurements. Then the isolator switch can be opened. For example, The isolator closes 1 ms after the rising edge of 110. If it switches into a short circuit, the voltage will drop (to zero). At times, the voltage drop across the cable (assuming the short circuit condition occurred towards the end of a cable) might prevent the voltage at the beginning of the cable to drop under a certain level. If this level is higher than the short circuit detection (“voltage off detection”; <=3V), a bus device will miss this important state and therefore not open its isolator. To overcome this, the bus master “mirrors” or “simulates” the short circuit condition by switching the loop voltage to 0 (zero).

A 500 microsecond pulse is then generated, as at 116. A current response from bus device(s), such as 24i, indicative of an alarm condition such as fire or gas, can be sensed as at 118. Finally, an optional 1.5 ms start pulse is provided if sounders, flashers or other output devices are to be activated, as at 120.

The bus master, such as 20i, can respond to different types of failures, all without limitation. For example, a failure of the secondary processor 34b can be detected by the primary processor 34a or the FACP 12. If the regularly transmitted message from the secondary processor 34b fails to arrive, the primary processor 34a goes into emergency operation mode after a predefined period of time. The redundant emergency operation path is then activated as discussed above.

A failure of the DC/DC supply module 50 can be detected through two channels such as 48a, b. The voltage is monitored by both of the processors 34a, b. If the 42V supply 50 fades gradually, the processor 34b can detect the failure and send a message via the UART to the primary side processor 34a. The secondary side processor 34b opens the relay 40a, b to the bus and goes into a defined state. The primary side processor 34b closes the emergency relay 36a, b.

If the 42V supply fails rapidly, and the secondary side processor 34b does not have enough time to send off a message, the failure can be detected by the primary side processor 34a via a voltage measurement circuit 48a or an aborted communication on link 18. The primary side processor 34a can then close the emergency relay 36a, b. Other failures can also be detected as would be understood by those of skill in the art.

In summary, embodiments of the invention provide almost full hardware redundancy in the bus masters, a redundant “emergency path”, which can compensate for a failure of >90% of components on the secondary side; the primary side is able to check itself; external power supplies as well as regulators functioning as internal power supplies. In addition, software and firmware redundancy is provided via two CPUs, no power reduction during emergencies, the emergency mode still offers communications with a reduced protocol. Selective control, including synchronizing of indicating devices such as sounders and flashers can be provided. The protocol transmits reference time, and, cable or bus device faults can be handled.

In contrast to known systems, complete on board redundancy can be provided via a second signal path via elements 36a/b, 38, 34a, and 18b. Since almost any component on the secondary side 32b might fail, the emergency path completely bypasses all of them at once, by switching relays 36a/b. The 42V backup supply voltage 18a is completely separated from the rest of the on board power supplies. The primary side is also able to check its own functionality. If anything goes wrong, processors 34b can send a fault report to the FACP (main CPU) 12.

Additionally, as discussed above, indicating devices are activated by an optional pulse {120}. If this pulse is missing, nothing happens. If it is sent, a pre-selected set of devices is activated. The selection of the bus devices that should be activated is preprogrammed by the FACP 12 depending on user input.

Those of skill in the art will understand that while the invention has been described in connection with fire alarm systems, it is not so limited. Embodiments of the invention have applicability in connection with other types of ambient condition sensing systems including gas detection systems, intrusion detection systems, HVAC-type systems and the like all without limitation.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A monitoring system comprising:
a common control unit;
supplemental units displaced from the control unit;
a primary communications bus between control unit and at least some of the supplemental units; and
at least one supplemental communications bus which extends between the control unit and at least some of the supplemental units where the supplemental bus is activated in response to at least one of, a sensed failure of one of the units, or, a sensed failure associated with the primary communications bus.

2. A system as in claim 1 where supplemental units are selected from a class which includes at least, ambient condition detectors, audible alarm indicating output devices, visual alarm indicating output devices, and bus control units.

3. A system as in claim 2 where the detectors are selected from a class which includes at least, smoke detectors, flame detectors, thermal detectors, gas detectors, humidity detectors, and intrusion detectors.

4. A system as in claim 1 where a first portion of the primary communications bus extends between the control unit and at least first and second bus control units with a second portion of the primary communications bus extending between at least one of the bus control units and a plurality of other supplemental units.

5. A system as in claim 4 where at least a portion of a supplemental communications bus extends between some of the supplemental units and the control unit.

6. A system as in claim 5 where supplemental units are selected from a class which includes at least, ambient condition detectors, audible alarm indicating output devices, visual alarm indicating output devices, and bus control units.

7. A system as in claim 6 where the supplemental communications bus extends between at least one of the bus control units and the control unit.

8. A system as in claim 6 where the common control unit comprises a fire alarm control panel which includes a programmable processor and at least one power supply.

9. A system as in claim 8 where the supplemental bus is activated in response to at least one of a processor failure, a power supply failure, or, a bus failure.

10. A system as in claim 9 which includes at least one bus control unit, coupled to the primary communications bus, and where the supplemental bus is activated in response to at least one of a failure of the bus control unit, or a failure of the common control unit.

11. A system as in claim 10 where the bus control unit includes primary and secondary control circuits which are electrically isolated from one another.

12. A system as in claim 11 where the common control unit periodically transmits a status indicating signal on the primary communications bus, and where at least one of the primary or secondary control units monitors the bus for the presence of the status indicating signal, and, activates the supplemental communications bus in response to the absence thereof.

13. A method comprising:
providing an ambient condition monitoring system having spaced apart components some of which transmit information to one another;
transmitting information as to at least one sensed condition between some of the components; and
monitoring an operational aspect of at least part of the system associated with the transmitting process and in response to establishing the presence of at least one detected failure in the transmitting process, switching transmitting between first and second communications systems.

14. A method as in claim 13 which includes sensing operational conditions in at least one of the components and, in response to detecting a failure of the component, switching transmitting between first and second communications systems.

15. A redundant ambient condition communications system comprising:
a plurality of ambient condition detectors;
a plurality of communications links; and
a control unit coupled to the links and where at least some of the links are coupled to at least some of the detectors with the detectors and the control unit in communication, via at least some of the links, and where a communication failure can be detected and communications restored, at least in part, via different links.

16. A system as in claim 15 where the control unit includes circuitry to couple a status indicating signal to some of the links and displaced circuitry which, in the absence of the status indicating signal, detects a communication failure whereupon, communications are restored, at least in part, via different links.

17. A system as in claim 15 which includes at least one bus control unit coupled to a common control unit and to at least some of the communications links.

18. A system as in claim 17 where the bus control unit includes at least one programmable processor and circuitry to monitor at least some of the communications links and in response to absence of a predetermined condition, restores communications, at least in part, via different links.

19. A system as in claim 17 where the bus control unit includes first and second programmable processors where at least one processor monitors at least some of the links for a communication failure and where the other processor monitors other conditions of the bus control unit.

20. A system as in claim 19 where the programmable processors communicate with one another via optically isolated circuitry.
